(19) United States
(12) Patent Application Publication
(10) Pub. No.: US 2012/0222705 A1
(43) Pub. Date: Sep. 6, 2012

(54) DISHWASHER AND CORRESPONDING METHOD FOR OPERATING IT

(75) Inventors: Winfried Steiner, Nurnberg (DE); Rolf Stahlmann, Wolframs-Eschenbach (DE); Stefan Fuglein, Nurnberg (DE); Klaus-Martin Forst, Zirndorf (DE)

(73) Assignee: ELECTROLUX HOME PRODUCTS CORPORATION N.V., Brussel (BE)

(21) Appl. No.: 13/369,517

(22) Filed: Feb. 9, 2012

Related U.S. Application Data
(62) Division of application No. 11/576,717, filed on Oct. 30, 2008, now abandoned.

(30) Foreign Application Priority Data
Oct. 20, 2004 (EP) 04 024 910.4

(51) Int. Cl. B01D 35/16; B08B 7/04

(52) U.S. Cl. 134/18

(57) ABSTRACT

The invention relates to a dishwasher comprising a washing chamber, a water collection sump, a circulation pump, a circulation filter system with a flat filter arranged between the washing chamber and the water collection sump and a discharge section arranged between a discharge pump and the washing chamber.

In accordance with the present invention, the dishwasher is provided with a filter cleaning mode and the filter cleaning mode comprises the steps of:
decreasing the power of the circulation pump (4) in such a way that the water level in the water collection sump (2) increases and at least some of the deposits of the flat filter (7) are floated
increasing the power of the circulation pump (4) in order to draw the floating deposits into the discharge section (10).

The present invention relates to a dishwasher comprising a washing chamber, a water collection sump, a circulation pump, a circulation filter system with a flat filter arranged between the washing chamber and the water collection sump and a discharge section arranged between a discharge pump and the washing chamber. Further, the invention relates to a corresponding method for operating the dishwasher.

Such a dishwasher is e.g. known from EP 222 306 A1. The water collection sump communicates with the washing chamber through a fine-mesh flat filter. The flat filter retains particulate matter carried by the water flowing from the washing chamber into the water collection sump. It therefore prevents that the particulate matter enter the circulation and block the nozzles of the spraying arms. The flat filter is formed with an opening for a discharge section through which the interior of the washing chamber communicates with the intake of the discharge pump. The discharge section usually houses a coarse sieve, which serves the main purpose of retaining large particles, which might otherwise obstruct or damage the rotor of the discharge pump.

The known dishwasher is provided with nozzle means directing a water jet onto the surface of the flat filter for the cleaning of the flat filter.

It is an object of the present invention to provide a dishwasher with an improved filter cleaning mechanism.

This object is achieved according to the invention with a dishwashing machine as claimed in claim 1, which is characterized in that the dishwasher is provided with a filter cleaning mode comprising the steps of:
decreasing the power of the circulation pump in such a way that the water level in the water collection sump increases and at least some of the deposits of the flat filter are floated
increasing the power of the circulation pump in order to draw the floating deposits into the discharge section.

A corresponding method for operating a dishwasher is indicated in claim 11.

The dishwasher according to the invention comprises a filter cleaning mode in which the cleaning of the flat filter is performed by means of a smart control of the circulation pump.

The cleaning is performed in at least two steps. In a first step, the circulation pump power is decreased. The expression “decreasing” is used here in a broad sense, i.e. to state that the circulation pump power is reduced in such a way that the water level in the water collection sump increases. The expression “decreasing” includes a switching off of the circulation pump. When the water level increases above the surface of the flat filter, the deposits of the flat filter are floated, i.e. are lifted by the water.

Then, in the second step, the circulation pump power is increased again. The expression “increasing” is also used in a broad sense here, i.e. to state that the circulation pump power is enhanced in such a way that the water level in the water collection sump decreases. The expression “increasing” includes a switching on of the circulation pump. In the second step the floating deposits are drawn into the discharge section and the water level decreases below the flat filter. This leads to a transport of the deposits from the flat filter to the discharge section.

The invention has several advantages. It is a very easy, cheap and reliable way of cleaning the filters. In addition, no further means are necessary for cleaning the filters. Besides, it offers a lot of flexibility for cleaning the filters.

The invention overcomes the prejudice that the water level in the water collection sump should always be below the level of the flat filter. This prejudice is based on the assumption that deposits which have settled on the flat filter should be kept there and should not float around anymore.

According to a preferred embodiment of the present invention, the filter cleaning mode comprises the steps of:
switching off the circulation pump in such a way that the water level in the water collection sump increases and at least some of the deposits of the flat filter are floated
switching on the circulation pump in order to draw the floating deposits into the discharge section.

The switching off of the circulation pump is equivalent to decreasing the circulation pump power to zero. The switching off has a very advantageous cleaning effect. In this preferred embodiment of the invention the water flows in the opposite direction compared with the water flow during a cycle with a running circulation pump. In other words, the water flows from the water collection sump towards the flat filter and the washing chamber. This back sloshing water leads to a very advantageous cleaning of the flat filter. In addition, the water level increases very quickly when the circulation pump is switched off. This results in a advantageous floating of the deposits which have settled on the surface of the flat filter.

As soon as the deposits of the flat filter float, the circulation pump is switched on again. When the circulation pump starts up, the water level decreases below the surface of the flat filter and the floating deposits are drawn into the discharge section. The start up of the circulation pump should preferably be very fast in order to optimise the cleaning effect. The faster the start up of the circulation pump, the better is the transport of the floating deposits from the flat filter into the discharge section.

A further advantage of this preferred embodiment is that the time for cleaning the filters is very short.

According to another exemplary embodiment of the invention, the steps decreasing the circulation pump power and increasing the circulation pump power are performed at least twice in the filter cleaning mode. This means that the dishwashing machine is provided with a filter cleaning mode which performs at least the “decreasing-increasing-decreasing-increasing” steps of the circulation pump power. These repeated and successive cleaning steps intensify the filter cleaning effect. The number of repetitions may be chosen as a function of the loading of the filters, or in other words in dependence on the clogging of the filters. The more the filters are loaded or clogged respectively, the more often the cleaning steps should be repeated.

According to another preferred embodiment of the invention, the dishwasher comprises several cleaning phases and at least one of the cleaning phases comprises at least one break for performing the filter cleaning mode.

Such cleaning phases are e.g. a prewash phase, a main wash phase, a cold rinse phase and a hot rinse phase. According to this preferred embodiment at least one of these phases comprises a break. In this break the filter system is cleaned by means of the filter cleaning mode. This prevents a loading or clogging respectively of the filter system during these phases. In known dishwashers the cleaning of the filter system is only performed between the different cleaning phases. However, in particular with very dirty dishes, it may happen that the filters get very loaded or even blocked during one of the cleaning phases. The intermediate cleaning breaks according to this preferred embodiment of the invention prevent a loading of the filters during the cleaning phases.

According to another preferred embodiment of the invention, the main wash phase comprises at least one break for performing the filter cleaning mode.

As the main wash phase is usually the cleaning phase which produces the maximum load of the filters, it is advantageous to perform a cleaning break during the main wash phase.

According to another preferred embodiment of the invention, at least one of the cleaning phases comprises periodical breaks for performing the filter cleaning mode. This periodical cleaning of the filters improves the cleaning effect further and prevents a blocking of the filters during a cleaning phase.

According to another preferred embodiment of the invention, the power of the circulation pump is controlled in such a way that the water level in the water collection sump is below the flat filter with the exception of the break for performing the filter cleaning mode.

During the normal dish cleaning parts of the cleaning phase, the circulation pump runs and the water circulates between the washing chamber and the water collection sump. During these normal dish cleaning parts of the cleaning phases, the water level in the water collection sump is kept below the flat filter. However, in the intermediate break or breaks in which the circulation pump is switched off or the power of the circulation pump is decreased, the water level in the water collection sump increases above the surface of the flat filter in order to float the deposits of the flat filter.

According to another preferred embodiment of the invention, the duration of the respective breaks in which the filter cleaning mode is performed is substantially shorter than the duration of the respective cleaning phases.

The duration of the breaks is mainly determined by the time which is necessary to increase the water level in the water collection sump above the surface of the flat filter. The more loaded the filter system of the dishwasher is, i.e. the more deposits have settled on the surface of the filters, the longer the water needs to reach the level of the flat filter when the circulation pump is switched off or the power is decreased. The dishwasher is preferably provided with a water level sensor which measures the water level in the water collection sump and sends a signal to a control unit of the dishwasher when the water level has reached a predetermined level above the surface of the flat filter. But in total, the duration of the intermediate filter cleaning breaks is usually substantially shorter than the duration of the respective cleaning phases. A typical duration of the main wash phase is e.g. 1 hour, while a typical duration of a filter cleaning break is in a range between a few seconds and a few minutes.

According to another preferred embodiment of the invention, the dishwasher comprises a turbidity sensor for measuring the turbidity of the circulating water. The filter cleaning mode is activated as a function of the measurements of the turbidity sensor.

In this preferred embodiment of the invention, the filter cleaning mode is activated automatically when the turbidity of the circulating water reaches a predetermined treshhold. This embodiment ensures for all kinds of dishes that the filters are not blocked up, but cleaned on time. Besides, it guarantees a very efficient use of the filter cleaning mode, as it is only activated when it is necessary.

The turbidity sensor is arranged somewhere in the water circulation cycle, preferably in the water collection sump. When the turbidity of the circulating water has reached the predetermined treshhold, the turbidity sensor sends a control signal to a control unit of the dishwasher and the filter cleaning mode is started.

According to another preferred embodiment of the invention, the filter cleaning mode is performed between the cleaning phases, in particular between the main wash phase and the rinsing phase.

This preferred embodiment has the advantage that the cleaning phases do not have to be interrupted by intermediate breaks. The filter cleaning mode is performed during the breaks between the different cleaning phases. This preferred embodiment of the invention is in particular useful when a cleaning of the filters is not necessary during the cleaning phases, e.g. when the dishes are only slightly dirty.

It may be seen as the gist of the present invention that a cleaning of a dishwasher's filter system can be achieved by a specific pulsed water level in the water collection sump. The pulsed water level may be achieved by a pulsed control of the circulation pump power. The upper amplitude of the water level pulse should be above the surface of the flat filter and the lower amplitude of the water level should be below the surface of the flat filter.

These and other aspects of the present invention will become apparent from and elucidated with reference to the embodiments described hereinafter.

Exemplary embodiments of the present invention will be described in the following, with reference to the following drawings:

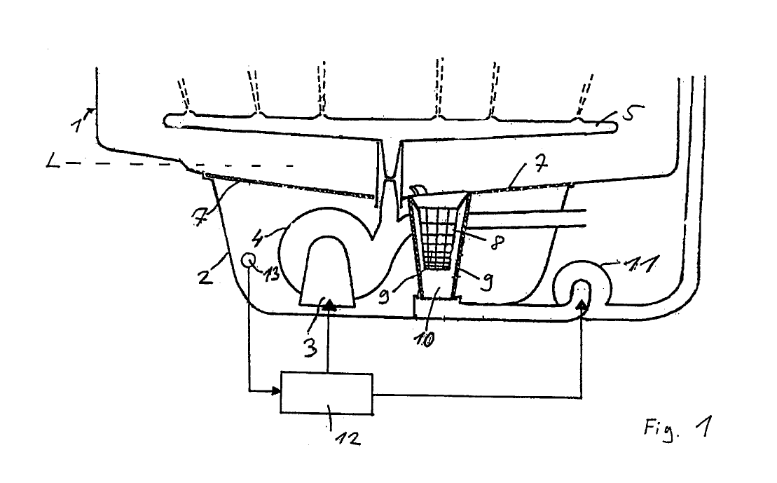

FIG. 1 shows a schematic vertical section of a dishwasher according to the invention

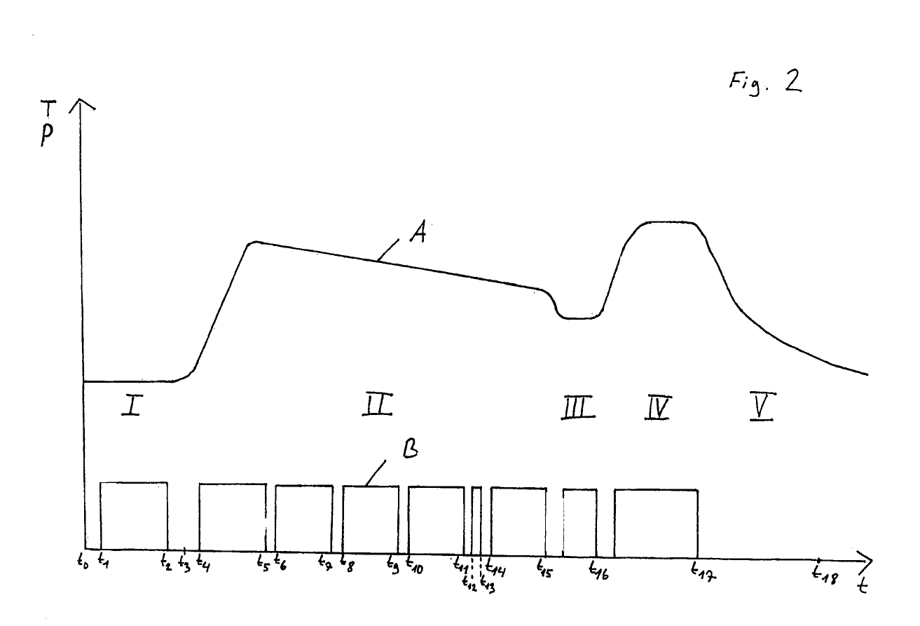

FIG. 2 shows schematically a cycle profile of a dishwashing program with the power of the circulation pump and the temperature of the water for rinsing

FIG. 1 shows schematically a vertical section through a dishwasher according to the invention. The dishwasher comprises a washing chamber 1, which is only partially shown. The bottom of the washing chamber 1 is formed with a water collection sump 2 for collecting the washing and rinsing water. Located in the sump 2 is the intake section 3 of a circulation pump 4 for the supply of water to a lower rotating spray arm 5 and a not shown upper rotating spray arm for spraying the water onto the not shown dishes to be washed in a known manner.

Disposed in the washing chamber 1 is a circulation filter system which is installed in the flow path of the water sprayed onto the not shown dishes and flowing back into the sump 2 for being recirculated by the circulation pump 4. The circulation filter system comprises a fine mesh flat filter 7 as a first part below the lower spray arm 5.

The flat filter 7 is formed with a frustoconical portion housing a removable large coarse sieve 8 of a corresponding shape installed in the flow path of the water from the washing chamber 1 to the discharge section 10 of a discharge pump 11. The coarse sieve 8 protects the discharge pump 11 from coarse impurities, such as bits of glass, bones and the like which might otherwise obstruct or even damage the discharge pump 11. The frustoconical portion also houses a fine mesh filter 9 which forms the second part of the recirculation filter system.

The dishwasher as shown in FIG. 1 also comprises a electrical control unit 12 for controlling the course of the dishwashing programs. The control unit 12 is coupled with a turbidity sensor 13, which is arranged in the water collection sump 2. The turbidity sensor 13 measures the turbidity of the circulating water and delivers a measurement signal to the control unit 12. The control unit 12 is further coupled with the circulation pump 4 and the discharge pump 11 and delivers control signals to the circulation pump 4 and the discharge pump 11.

FIG. 2 shows schematically an exemplary embodiment of a cycle profile of a dishwashing program, which may run on a dishwasher according to the invention as shown in FIG. 1. In the explanations of the cycle profile, reference is made to the parts of the dishwasher of FIG. 1. The cycle profile is shown in a very simplified way.

In FIG. 2, the ordinate represents the time t, while the abscissa represents the temperature T of the water for rinsing and the circulation pump power P of the circulation pump 4. The curve A shows the temperature T of the water for rinsing and curve B the corresponding circulation pump power P. The representation of the cycle profile is not true to scale. The cycle profile of FIG. 2 comprises a prewash phase I, a main wash phase II, a cold rinse phase III, a hot rinse phase IV and a drying phase V. At time tₒ, the program starts with a prewash phase and water for rinsing is filled into the dishwasher. At time t₁, the filling is completed and the circulation pump 4 is started. Thus, the water is circulated by means of the circulation pump 4. At time t₂, the circulation pump 4 is switched off and the discharge pump 11 is switched on. The discharge pump 11 pumps out the water for rinsing. This is finished at time t₃. At time t₃, the mainwash phase starts and fresh water for rinsing is filled into the dishwasher. At time t₄, the filling is finished and the circulation pump 4 is switched on again. At time t₅, the mainwash phase is interrupted by a short intermediate filter cleaning break to perform a filter cleaning mode. During the filter cleaning mode the circulation pump 4 is switched off. This results in a back sloshing of the water in the water collection sump 2 and the water flows in the opposite direction, i.e. from the water collection sump 2 towards the washing chamber 1. Thus the water gathers in the water collection sump 2 and the water level increases. Due to the increasing water level, the fine mesh filter 9 and the coarse sieve 8 are cleaned first. With a further increase of the water level the flat filter 7 is also cleaned. Due to the increasing water level, the deposits of the coarse sieve 8, the flat filter 7 and the fine mesh filter 9 are floated. The circulation pump 4 is switched off preferably until the water level in the water collection sump 2 has increased to a level above the whole flat filter 7 in order to float the deposits of the whole flat filter 7. This preferred water level is indicated as level “L” in FIG. 1. At time t₆, the water level has reached this level “L” above the surface of the flat filter 7. Now the circulation pump 4 is switched on again. The direction of the water flow turns therefore again and the water level starts to decrease. The floating deposits of the flat filter 7 are drawn into the discharge section 10 of the dishwasher and do not load the flat filter 7 anymore. The time interval between t₅ and t₆ may be predetermined in advance by the specific cleaning program which is controlled by the control unit 12. Advantageously the time interval between t₅ and t₆ is set by the control unit 12 as a function of the time necessary to increase the water level on the level “L” above the surface of the flat filter 7. This time interval is in particular dependent on the loading of the flat filter 7, the coarse sieve 8 and the fine mesh filter 9. It may vary between a few seconds and several minutes. The more loaded the flat filter 7, the coarse sieve 8 and the fine mesh filter 9 are, the longer is the time to increase the water level above the surface of the flat filter 7. Advantageously, there are arranged not shown water level sensors in the washing chamber 1, which send a signal to the control unit 12 when the water level has reached the desired level “L”. Between time t₆ and t₇, the normal main wash program continues, but with cleaned filters thanks to the previous intermediate filter cleaning break. At time t₇ starts another filter cleaning break and the circulation 4 pump is switched off again. The water level in the water collection sump 2 increases again and with the increasing water level the coarse sieve 8, the fine mesh filter 9 and the flat filter 7 are cleaned and the deposits start to float. At time t₈, the water level has reached again the level. “L” above the surface of the flat filter 7 and the circulation pump 4 is switched on again. The direction of the water flow turns again and the water level starts to decrease. The floating deposits are transported with the flowing off water into the discharge section 10 of the dishwasher and do not load the flat filter 7 and the fine mesh filter 9 anymore. The normal main wash program continues again between time t₈ and t₉. An additional filter cleaning break during the mainwash program is provided between time t₉ and time t₁₀. At time t₁₁ another intermediate filter cleaning break starts. During this break the circulation pump 4 is switched on and off twice. At time t₁₁, the circulation pump 4 is switched off. At time t₁₂, it is switched on. At time t₁₃, it is switched off and at time t₁₄, it is switched on again. This repetition of the filter cleaning steps intensifies the filter cleaning effect. At time t₁₅, the main wash program ends. The circulation pump 4 is switched off and the water for rinsing is pumped out by means of the discharge pump 11. The water collection sump 2 is then filled again with fresh water, the cold rinse phase starts and is performed in the known manner.

At time t₁₆, the cold rinse phase ends. Now again the dirty water is pumped off by means of the discharge pump 11 and fresh water is filled into the water collection sump 2. Then the hot rinse phase is performed until time t₁₇. The dishwashing program finally ends by a drying phase, which ends at time t₁₈. The cleaned and dried dishes can now be taken from the washing chamber by the user.

In the above described exemplary embodiments of the invention, the filter cleaning mode is only performed in the mainwash phase II of the cleaning program and in periodical time intervals of e. g. 10 minutes.

According to other exemplary embodiments of the present invention, the filter cleaning mode may be also performed in the prewash phase I and/or the cold rinse phase III and/or the hot rinse phase IV of the cleaning program. Generally the filter cleaning mode may advantageously be used in all phases in which water is circulated by means of the circulation pump.

According to other exemplary embodiments of the present invention, the repetitions of the filter cleaning steps as shown between time t₁₁ and time t₁₄ may be performed in all filter cleaning breaks. The number of repetitions can also be 3, 4 or more. According to other exemplary embodiments of the present invention, the number of repetitions is chosen in a flexible way as a function of the loading of the filters or the turbidity of the circulating water.

According to another exemplary embodiment of the present invention, the filter cleaning mode is not performed in periodical time intervals, but as a function of the turbidity measurements of the turbidity sensor 13. The turbidity sensor 13 measures the turbidity of the circulating water. When the turbidity has reached a predetermined treshhold, the turbidity sensor 13 sends a control signal to the control unit 12 and the control units 12 initiates the filter cleaning mode. This exemplary embodiment of the invention offers a lot of flexibility. The filter cleaning mode is only performed when necessary, but it also ensures under all circumstances that the flat filter 7, the coarse sieve 8 and the fine mesh filter 9 are not getting overloaded. This ensures an optimal performance of the dishwashing process.

The above described exemplary embodiments of the invention may also be combined in several advantageous ways.

What is claimed is:

1. A method for operating a dishwasher comprising:
performing a filter cleaning mode for cleaning a washing chamber circulation filter system, the filter system having a flat filter (7) arranged between a washing chamber (1) and a water collection sump (2), the filter cleaning mode comprising:
decreasing a power of a circulation pump (4) to increase a water level in the water collection sump (2), which causes at least some deposits of the flat filter (7) to be floated; and
increasing the power of the circulation pump (4) after said decreasing, which causes the floated deposits to be drawn out of the washing chamber (1) into a discharge section (10) of the dishwasher,
wherein the discharge section (10) is arranged between the washing chamber (1) a discharge pump (11).

2. The method for operating the dishwasher of claim 1, further comprising:
after said increasing, resuming performing a main wash phase, wherein the deposits that were drawn into the discharge section do not load the flat filter (7).

3. The method for operating the dishwasher of claim 1, wherein steps of the filter cleaning mode are controlled by a control unit (12) that is operationally connected to the circulation pump and the discharge pump.

4. The method for operating the dishwasher of claim 3, the filter cleaning mode further comprising:
controlling the power of the circulation pump (4) with the control unit (12) to keep a water level in the water collection sump (2) below the flat filter (7) except during the filter cleaning mode.

5. The method for operating the dishwasher of claim 4,
wherein said decreasing the power of the circulation pump (4) causes the circulation pump (4) to switch off, and
wherein said increasing the power of the circulating pump (4) causes the circulation pump (4) to switch on.

6. The method for operating the dishwasher of claim 4, further comprising:
controlling the power of the circulation pump (4) with the control unit (12) during the filter cleaning mode to, at least twice during a main wash program, perform:
said decreasing the power of the circulation pump (4); and
said increasing the power of the circulation pump (4).

7. The method for operating the dishwasher of claim 4, further comprising:
controlling plural cleaning phases with the control unit, wherein at least one of the plural cleaning phases comprises at least one break for performing the filter cleaning mode.

8. The method for operating the dishwasher of claim 7, wherein said at least one of the plural cleaning phases comprises periodic breaks for performing the filter cleaning mode.

9. The method for operating the dishwasher of claim 7, wherein a duration of said at least one break in which the filter cleaning mode is performed is shorter than duration of said at least one of the plural cleaning phases.

10. The method for operating the dishwasher of claim 7, wherein said at least one of the plural cleaning phases is a main wash phase.

11. The method for operating the dishwasher of claim 4, further comprising:
measuring a turbidity of circulating water with a turbidity sensor (13), wherein the control unit (12) activates the filter cleaning mode as a function of measurements received from the turbidity sensor (13).

12. The method for operating the dishwasher of claim 4, wherein the control unit is adapted to perform the filter cleaning mode between a main wash phase and a rinsing phase.

13. The method for operating the dishwasher of claim 4, further comprising:
sensing a water level with a water level sensor that is operationally connected to the control unit.

14. The method for operating the dishwasher of claim 13, wherein the water level sensor is disposed in the washing chamber.

15. A dishwasher adapted to perform the method of claim 1.

16. A method for operating a dishwasher comprising:
controlling a power level to a circulation pump in the dishwasher to keep a water level in a water collection sump below a flat filter except during a break for performing a filter cleaning mode, wherein the dishwasher comprises: a circulation filter system with the flat filter arranged between a washing chamber and the water collection sump;
controlling several cleaning phases within the dishwasher, wherein at least one of the several cleaning phases comprises at least one break for performing the filter cleaning mode during which the circulation pump is switched off or its power is decreased;
said filter cleaning mode for cleaning the circulation filter system comprising:
decreasing the power of the circulation pump (4) to increase the water level in the water collection sump (2) above a surface of the flat filter (7) and at least some deposits of the flat filter (7) are floated;
increasing the power of the circulation pump (4) to draw the deposits that were floated into a discharge section (10), wherein the discharge section is arranged between a discharge pump and the washing chamber.

17. A method for operating a dishwasher comprising:
controlling a power level to a circulation pump in the dishwasher to keep a water level in a water collection sump below a flat filter except during a break for performing a filter cleaning mode, wherein the dishwasher comprises: a circulation filter system with the flat filter arranged between a washing chamber and the water collection sump;
controlling several cleaning phases within the dishwasher, wherein at least one of the several cleaning phases comprises at least one break for performing the filter cleaning mode during which the circulation pump is switched off or its power is decreased;
said filter cleaning mode for cleaning the circulation filter system comprising:
switching off the power to the circulation pump (4) to increase the water level in the water collection sump (2), which causes at least some deposits of the flat filter (7) to be floated; and
switching on the power to the circulation pump (4) to draw the deposits that were floated into a discharge section (10), wherein the discharge section is arranged between a discharge pump and the washing chamber.
